(19) United States
(12) Patent Application Publication
(10) Pub. No.: US 2012/0060085 A1
(43) Pub. Date: Mar. 8, 2012

(54) METHOD AND EQUIPMENT OF ASP SERVICE FOR MULTI-RESOLUTION IMAGE ON THE ENVIRONMENT OF MULTI-SERVER

(75) Inventor: Jeong-Soo KWAK, Seoul (KR)

(73) Assignee: VR PHOTO CO., LTD., Seoul (KR)

(21) Appl. No.: 13/296,008

(22) Filed: Nov. 14, 2011

Related U.S. Application Data
(63) Continuation of application No. 10/545,995, filed on Aug. 1, 2006, now abandoned.

(30) Foreign Application Priority Data
Feb. 20, 2003 (KR) 10-2003-0010849
Feb. 19, 2004 (KR) PCT/KR2004/000333

(51) Int. Cl. G06F 17/00

(52) U.S. Cl. 715/234

(57) ABSTRACT

A method and apparatus are provided in which an Application Service Provider (“ASP”) generates a multi-resolution image on a multi-web server to provide the total process to manufacture the multi-resolution image, up-load to the image to the server, as well as to put it into web in one service. The process can be embodied to link an ASP Service Developer server, an ASP Service Operator server, and a Multi-Web Server. The desired functions can be performed by the client that needs the image. Therefore, all of the process from image manufacturing to start business through web can be realized easily and with low cost.

### CROSS-REFERENCE TO RELATED APPLICATIONS

This application claims priority under 35 U.S.C. §120 to patent application Ser. No. 10/545,995, filed on Aug. 1, 2006, in the United State Patent and Trademark Office, the disclosure of which is incorporated herein by specific reference thereto.

### TECHNICAL FIELD

This invention is in relation with the methods and equipments of Application Service Provider (hereinafter called “ASP”) for multi-resolution image on Multi-Web Server to provide the total process to manufacture multi-resolution image, up-loading to server as well as to put up on the net work including the Internet in one service.

### BACKGROUND ART

So far, expensive multi-resolution image manufacturing solution has to be purchased in order to provide multi-resolution image on the network including the Internet. However, in case of the image processing solution realized in net work, it is recommendable to use in the form of ActiveX OCX Component, protection measure is not so suitable due to the features of the ActiveX OCX Component.

For example, even if shopping mall operator manufactured multi-resolution image, program of shopping mall has to be revised in order to show it to Netizen, and it would be almost impossible to revise the program by ordinary people as it is highly sophisticated technical job.

Furthermore, in case of the overseas companies developing multi-resolution image manufacturing solution, they like to supply the developed solutions to a lot of ordinary users to ensure their earnings than limited number of web site construction companies. However, practically ordinary users have limited know-how and related equipment to manufacture multi-resolution image, up load to server and put up into web to show it to ordinary users. For this reason, they inevitably supply to web site construction companies and they face limited market development.

Furthermore, there are still remain the question that how much sales increase can be expected even if the multi-resolution image provided to Netizens to display commodities in shopping mall. That is, no one can sure that the multi-resolution image with much expense and efforts is really necessary.

To solve this problem, there is an attempt to apply multi-resolution image to investigate customer preference trends. This is the method to investigate preference trends by clear image piece units down loaded from server when each reduced multi-resolution image obtained from the original image and divided into same size have been enlarged by Netizen onto specific part.

Especially, in order to investigate preference, it is necessary to analyze the collected result through e-mail sent to a lot of Netizen with much amount of expense and efforts after manufacturing multi-resolution image. In this case, the investigation of preference per each image unit in piece may be possible problem.

For example, Toyota Motors is investigating the preference in Korea and China with much amount of expense, and suffering with the problem that accurate investigation of preference is impossible as the investigation has to be progressed through photographed car image divided in tile type pieces in this test method.

This problem is derived from the fact that accurate investigation of preference for audio or for fuel instrument panel is impossible as there may be exist complex images such as instrument panel and audio etc. in the grid type image in pieces if we suppose the photographed image is of front side car interior.

Furthermore, usually most of the Netizen feel inconvenience to respond this kind of investigation for preference as they are facing on lots of requests to respond so may research and investigation through Spam e-mails.

However, in the Netizens point of view, they use to have desire to observe any interesting commodities carefully and in the sellers point of view, they have to read the desire of Netizens through maximize the efficiency with less expense.

Especially, in the Netizen's psychological point of view, there are a certain trends that most of the Netizens to respond on the request to apply premium that can be closed to any commodity interested but not decided yet to purchase. Through these kinds of application process they can remember relevant commodities for a long time.

As we can realize in this case, Netizen's trends and characteristic analysis are very important element for the commodity sellers, however, expensive solutions have to be purchased so far to do this job.

Also, it is recommendable the image to put up into middle/large scale portal site, however, system developer use to avoid to entrust other server for the operation as the protection measure for illegal usage of processing solution of ActiveX OCX type image is not ensured, and accurate settlement of account is not clear in calculation how many multi-resolution images have been manufactured and provided yet.

### DISCLOSURE OF INVENTION

The purpose of this invention is to provide the method and equipment for ASP service that any ordinary user without professional knowledge enable to manufacture multi-resolution image and put it into business by providing the total process to manufacture multi-resolution image, up-loading to server as well as to put up on the web in one service on Multi-Web Server composed by ASP Service Developer, ASP Service Operator and ASP Service Client Server in order to solve the problem described previously.

In addition, this invention provide the way to block illegal usage of image manufacture solution for image manufacture clients and to clear settlement of account between ASP Service Developer and ASP Service Operator.

Furthermore, this invention can provide as well improved preference survey method in accuracy to maximize advertisement on specific field of the commodity as it provide ASP service in middle/large scale portal site that has so many members or using by lots of Netizens through its feature that can proceed survey for commodity or inquiry easily.

In order to achieve the technical task described above, this invention provides the equipment to execute ASP service that provide multi-resolution image by linking ASP Service Developer, ASP Service Operator server that operate middle/large scale portal site, Image Manufacturing Client that posses application and OCX Component Part that Multi-Web Server including ASP Service Client Server which is operated by Image Manufacturing Client download image manufacturing program, ordinary Netizen Clients who are browsing images manufactured by Image Manufacturing Client and Internet communication network as well, as the base.

Also the ASP service method that provide multi-resolution image using multi web server mentioned above can include following steps.

Firstly, it includes the step that image manufacturing client connect to web server. Image Manufacturing Client down load image manufacturing program that composed application and OCX Component Part from Multi-Web Server Image Manufacturing Client log-in and treat service order and settle the account in order to authenticate the membership between application part of Image Manufacturing Client and Multi-Web Server.

Application part transfer necessary parameter to OCX Component Part in order to authenticate legal usage, recording of usage details and up-load.

Authentication for the legal usage in between Multi-Web Server and OCX component is executed to identify if order and account settlement has been processed before manufacturing, OCX component transfer usage details of image manufacturing client to ASP Service Developer Server and record the usage details in relevant data base of ASP Service Developer Server.

Image Manufacturing Client input image by using OCX component mentioned above and set parameter related image output form.

And this time, reducing step and calculation step of divided size for multi-resolution image is executed. Input images will be saved as divided multi-resolution image, the saved folder and file name will be based on the parameter transferred from application part. However, folder will be named as SavePath and web page will be named as PurchasID so that always new multi-resolution image can be created even though Multiple Image Manufacturing Clients manufacture multi-resolution image at the same time or identical Image Manufacturing Client manufacture multi-resolution image.

Image replacement and saving steps are included in this case to prevent illegal usage and manufacture web page that can be put up on the web.

This time, PurchasID will be used that was transferred as parameter from application part so that always new multi-resolution image can be created even though Multiple Image Manufacturing Clients manufacture multi-resolution image at the same time or identical Image Manufacturing Client manufacture multi-resolution image.

Above mentioned PurchasID will be created by mixture ShopID and present time so that it can be the unique order number, but also can be composed by addition or reduction of necessary item. The web page produced as described above upload into indicated server by Image Manufacturing Client.

As the last step, the uploaded web page will be put up on the web to provide to ordinary Netizen Clients by using the server designated by client.

And the put up step on the web can include viewer program download step, initial image download and display step as well as image reading support step.

As this invention can be unified or transferred the function between servers in above mentioned web servers, it is focused rather what kind of can be finally provided to Image Manufacturing Client by Multi-Web Server than which server play what kind of role.

Therefore, according to this invention, easy, low cost and rapid process of image is possible without construction of any other system as Image Manufacturing Client can be provided one service from image manufacturing to put up it on web and connect to a business.

### BRIEF DESCRIPTION OF THE DRAWINGS

FIG. 1 is the example to show the composition of ASP service system to provide multi-resolution image for multi web server in this invention.

FIG. 2 is the example to show the work for service general information table of member's information DB.

FIG. 3 is the example to show the work for service order control table of member's information DB.

FIG. 4 is the example to show the work for inquiry receipt table of inquiry number DB.

FIG. 5 is the example to show the work for inquiry statistics table of inquiry number DB.

FIG. 6 is the example to show the work for member's information table of member's information DB.

FIG. 7 is the example to show the work for inquiry statistics table of inquiry number DB.

FIG. 8 is the example to show the work for developer using details table of developer member's information DB.

FIG. 9 is the example to show the work for data composition for the image in general viewing.

FIG. 10 is the example to show the work for mutual replacement of the data in general viewing of FIG. 9.

FIG. 11 is the example to show the work for multi-resolution image that formed in tile composition occurred in photographing by digital camera or in reducing image from scanning by scanner by 50%

From FIGS. 12 to 30 is to explain the flow of the work of this invention.

FIG. 31 is the example to show the work designated specific field of multi-resolution image as link field

FIG. 32 is the example of the work to pop-up the link page when click the link field.

FIG. 33 is the example of the work for premium application form to pop-up when a certain time has passed in case the link field is for investigation of inquiry frequency.

<Description of the Symbols in the Figures>

| | |
|---|---|
| 10: Network | 11: Multi-Web Server |
| 12: ASP Service Developer Server | 13: ASP Service Operator Server |
| 14: ASP Service Client Server | 15, 18, 21, 26, 27: Application area |
| 16, 19: DB area | 17, 20, 22: Data storage area |
| 23: Client | 24: Netizen client |
| 25: Image Manufacturing Client | 28: OCX Component area |

### BEST MODE FOR CARRYING OUT THE INVENTION

From now on, proposed practical example of this invention will be explained with some FIGS.

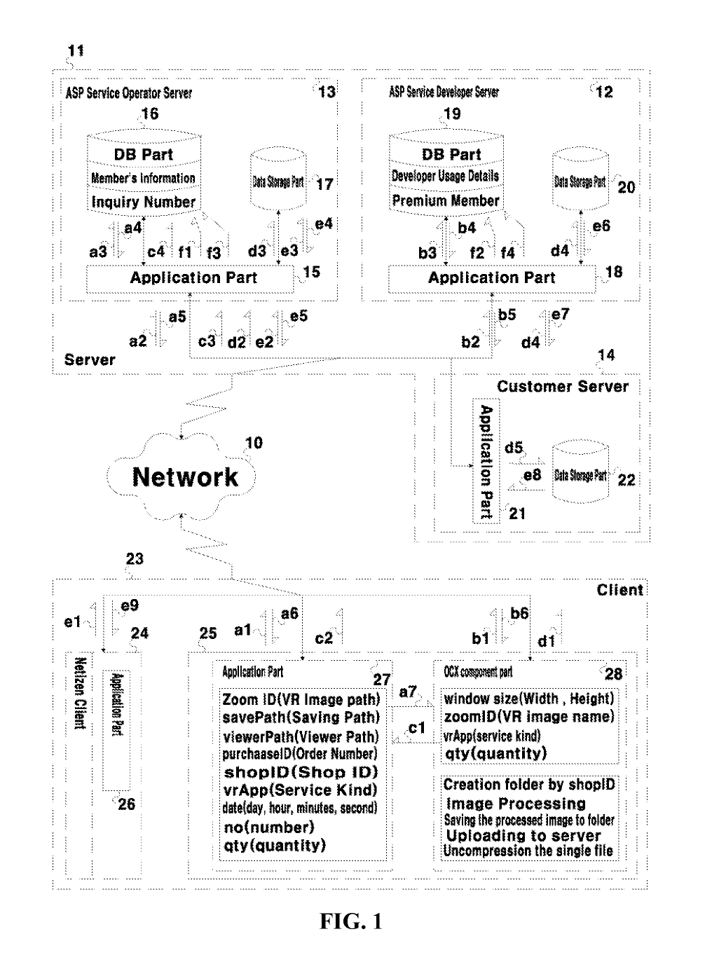

As you can see in FIG. 1, This invention can be composed to link ASP Service Developer Server(12) that developed multi-resolution image processing program solution, ASP Service Operator Server(13) of multi server for middle/large scaled portal site that has many members or is operating SOHO/professional shopping mall, multi-web server including ASP Clients Server that is operated by Image Manufacturing Client(25) that has a shop in any middle/large scaled portal site that using this invention (for example: SOHO mall of Yahoo Korea) and manufacture multi-resolution image and ordinary Netizen Client(24) surfing manufactured image by above Image Manufacturing Client based on Network(10) environment through Internet.

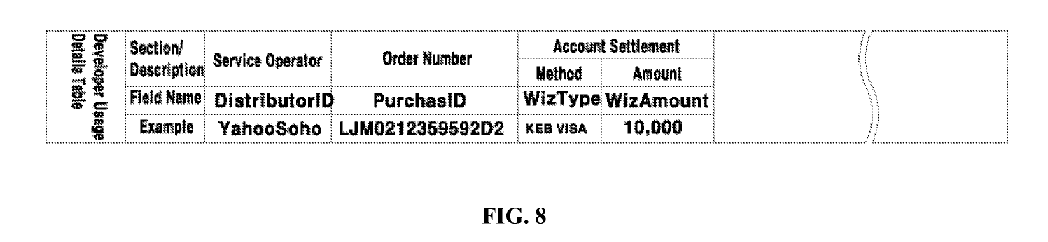

Above mentioned ASP Developer Server(12) can include Application Part(18) that include image manufacturing application and the application to display manufactured image, Data Storage Part(20) that can save manufactured multi-resolution image, text and voice data, Data Base Part(19) that include DB for premium members to register all data by activating premium application display when a certain time has passed from the time Netizen Client(24) start to read a certain area of multi-resolution image manufactured and developer usage details DB to register detailed data for usage by developer when multi-resolution image manufactured by execution of multi-resolution image manufacturing application installed on ASP Service Operator Server. FIG. 8 shows the example of Developer DB composition above.

Above ASP Service Operator Server(13) can include Application Part(15) that include multi-resolution image manufacturing application and application to display multi-resolution image manufactured, Data Storage Part(17) that can save manufactured multi-resolution image, text and voice data, Data Base Part(16) that include member's information DB to control data when Image Manufacturing Client(25) log-in to execute multi-resolution image manufacturing application, inquiry numbers DB to save and control inquiry numbers when any Netizen Client(24) start to search a certain area already assigned by Image Manufacturing Client(25) through multi-resolution image viewer application manufactured.

The ASP service Client Server(14) that is hold by Image Manufacturing Client(25), as ASP Service Client above, can include Data Storage Part(22) that can save multi-resolution image manufactured and the Application Part(21) that include image viewer program.

Above Image Manufacturing Client(25) can be down loaded applications necessary for image manufacturing form Operator Server(13) or Developer Server(12), and it can be composed with Application Part(27) and OCX Component Part(28).

Above Netizen Client(24) can include Application Part(26) in order to brows manufactured image after down load image viewer program.

The composition element of servers mentioned above is just an example and possible to execute in various form unless it does not influence on the series of service related image manufacturing, the key element of this invention. That is, ASP Service Operator Server(13) and ASP Service Developer Server(12) can be combined without any problem due to its similarity, and Data base part constructed in each server also has no problem even if the location will be changed.

Now, practical example for the service of this invention to be provided to Image Manufacturing Client and Netizen Client will be described in detail together with FIGS.(12-30).

Each steps shown on the FIGS.(12-30) can be divided as Multi-Web Server connecting and program downloading Step(201), Log-in Step(102;202-212), ordering and Account Settlement Step(103;213-228), Parameter Transferring Step to OCX Component Part(104;229-230), authentication for the legal usage and usage details Recording Step(105;231-237), Image Input Step((106;238-241), Multi-Resolution Image Reducing Step and Divided Size Calculation Step(107;255-258), Parameter Setting Step for image revision(108;242-271), Saving Step as Divided Multi-Resolution Image and Web Page Manufacturing Step including Image Data Replacement Step(109;272-298), Image Uploading Step(111;299-311) including Releasing Step for compressed single file(110;308-309) and Putting Up Step onto the web to provide manufactured web page to Netizen Client(112;359-417).

And also, parameter setting for the activities of preference survey and advertising such as premium application display or related process can be included in above step. Another explanation on this matter in this invention will be followed later in detail.

In the Multi-Web Server Connecting and Downloading Step(201), Image Manufacturing Client(25) is connected to Multi-Web Server(11), and Image Manufacturing Client(25) executes Program(a6) after transmitting the Program(a5) that enable multi-resolution image manufacturing according to the request(a1) of Image Manufacturing Client(25) following the request(a2) from Server(11).

The program transferred to Image Manufacturing Client(25) from Server(11) composed Application Part(27) and OCX Component Part(28).

The Log-in step(102;202-212) includes ID Input Step(202) that input ID, Saving Step(203) for input ID to variable shopID, Password Input Step(204), Log-in Step(205), Membership Information DB Connecting Step(206) that connect to Membership Information DB of Server(11) following log-in, Service General Information Table Opening Step(207) of Membership Information DB, and also includes reading folder name of service operator that pre-set when a member joined, reading multi-resolution image saving folder name, reading viewer folder name, saving service operator field value into variable DistributorID, saving the saving folder name field into variable SavePath, saving viewer folder name field into variable ViewPath, as well as general information reading step that close Service General Information Table of for Membership Information DB.

This is for multi-resolution image manufacturing program enable to calculate and control the service details per each ASP Service Operator Server and Image Manufacturing Client and also to manufacture multi-resolution images.

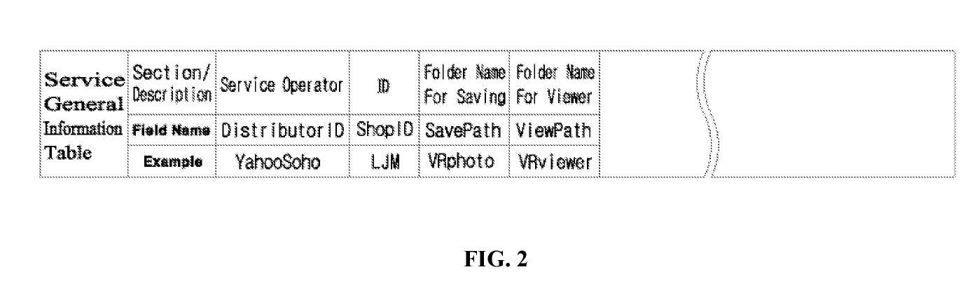

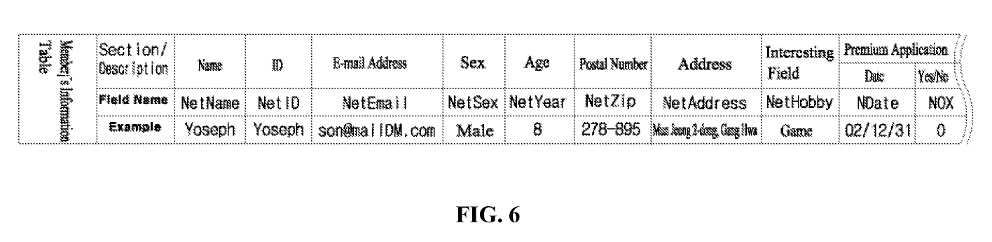

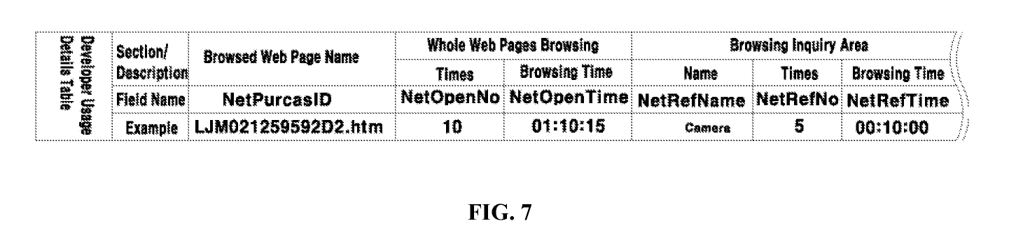

In addition, Membership Information DB herein can exist in ASP Service Operator Server(13) and ASP Service Developer Server(12) as well. FIG. 2 shows an example of service general information table composition and FIG. 6 shows an example of membership information table composition mentioned above.

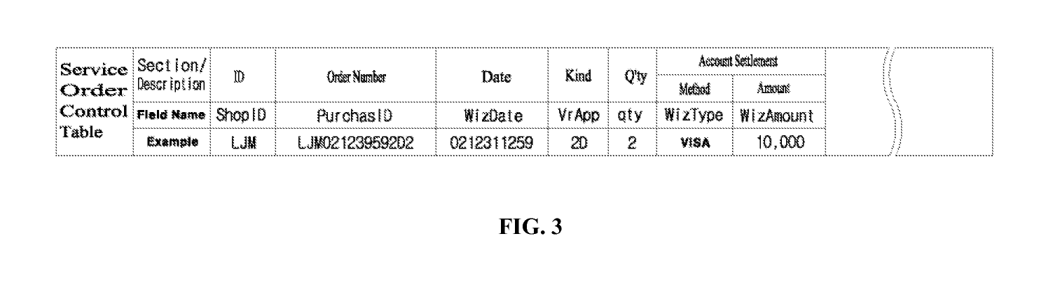

Ordering and Account Settlement Step(213-228) can include Service Order Control Table Opening Step(213) of Membership Information DB for saving ASP service order details selected by Image Manufacturing Client(25), Service Selecting Step(214) that select the kinds of service, Service Kinds Saving Step(215) that save selected service kinds to variable VrApp, Quantity Input Step(216) that input the quantity to manufacture multi-resolution images, Quantity Saving Step(217) that save the input quantity to variable qty, Settlement Account Calculation Step(218) that calculate settlement account according to the service kinds and quantity, settlement method Input Step(220) that save calculated amount into variable WizAmount and input the settlement method whether by credit card, by on-line transferring, by mobile phone or e-coin, Saving Step(221) that save input settlement method into variable WizType, Current Time Abstraction Step(222), Saving Step(223) that save abstracted current time into variable WizDate, Order Number Creating Step(224) that create order number by combining ShopID and abstracted current time to create unique numbers, Saving Step(225) that save create order number into variable PurchasID, saving step(226) that save Order Number(PurchasID), Current Time(WizDate), kinds of service(VrApp), quantity(qty), account settlement method(WizType), settlement amount(WizAmount) into service order control table of Membership Information DB in order to save ordering details, Account Settling Step(227) as well as Table Closing Step(228) for service order control of Membership Information DB. FIG. 3 shows the example of composition for Service Order Control Table mentioned above.

The kinds of service that can be selected in Service Selection Step(214) can include two-dimensional enlarged image service by one frame of multi-resolution image, three-dimensional enlarged image service by multi-frame of multi-resolution image, e-catalogue service that gives virtual image as if we are reading book by turn over the pages practically, e-album service that shows photographs in the form of album, panorama image service.

Order Number Creating Step(224) can create order numbers and combine Service Operator (DistributorID), ID(ShopID) and abstracted current time by adding Service Operator (DistributorID) if necessary in case many ASP Service Operator Servers(13) are exist.

The Log-in Step, Ordering and Account Settlement Step are steps processed in application part, the image processing program for multi-resolution image manufacturing is preferable for ActiveX OCX components. Accordingly, interface between Application Part and OCX Component Part is necessary. That is, Application Part is executed from Service Connecting Step(201) in FIG. 12 to Service Order Control Table Closing Step(228) of Membership Information DB in FIG. 13. Hereafter, in Parameter Transferring Step(229-230), relevant parameter is transferred(a7) to OCX Component Part(28) to operate(229) OCX Component Part(28). This time, transferred parameters are Service Operator (DistributorID), Order Number(PurchasID), Service Kinds(VrApp), multi-resolution image manufacturing Quantity(qty), ID(ShopID), multi-resolution image saving Folder Name(SavePath), Viewer Folder Name(ViewPath), ASP service operation and other items can be added or reduced if necessary. After transferring(c1) the parameter, OCX Component Part is operated(230).

In the authentication for the legal usage and usage details recording step(231-237), ASP Service Developer Server(12) receive the authentication request(b2, b3) upon authentication request(b1), this authentication result(b4, b5) will be transferred to Image Manufacturing Client(25), and then Manufacturing Client(25) check(231) if the execution is progressed in accordance with proper procedure based on the authentication result(b6) received by OCX Component Part(28).

If normal execution has been processed, then next procedure will be followed, if not, transferred(A) to Service Selection Step(214).

There will be a possible problem that any image manufacturing client may use OCX component illegally without additional payment against the intention of ASP Service Operator or ASP Service Developer as OCX component is usually executed successfully after download on the hard disk of client's computer.

Therefore, in order to solve this problem, OCX component has been designed to be executed only in the case that proper authentication has been received from ASP Service Developer Server(12) through Authentication Checking Step(231).

Furthermore, the application for the execution of Authentication Checking Step(231) can be performed through Application Part(15) of ASP Service Operator Server(13) or Application Part(18) of ASP Service Developer Server(12).

If OCX component has been performed through normal procedure, parameter that transferred through Application Part(27) of Image Manufacturing Client(25) will be saved in developer membership DB of ASP Service Developer Server(12), and then Usage Detail Saving Step(233-237) will be executed by saving usage details that which service and how many multi-resolution image has been manufactured by which ASP Service Operator Server in order to be utilized in account settlement between ASP Service Operators and Developers.

This procedure can be explained more concretely as follows;

After connecting(233) to Developer Membership Information DB; open(234) developer usage detail table; saving(235) parameter values transferred from Application Part(27) of Image Manufacturing Client(25) such as Service Operator(DistributorID), order number(PurchasID), service kinds(VrApp), multi-resolution image manufacturing quantity(qty), ID(ShopID), multi-resolution image saving folder name(SavePath), viewer folder name(ViewPath); and then close(236) the developer usage detail table of developer membership information DB; release(237) the connection of developer membership information DB.

In developer membership information DB connecting step above(233), steps (234), (235), (236), (237) can be simplify if necessary, these steps can be replaced by making folder name or file name, and save it data storage part of server after combining service operator(DistributorID), order number(PurchasID), service kinds(VrApp), multi-resolution image manufacturing quantity(qty) in one.

After OCX component executed and proved it performed through normal procedure by passing authentication and saved the usage details on ASP service developer server(12), regular manufacturing of multi-resolution image will be executed.

Image input step(238-241) includes page variable initialization step(238), original image input step(239) for manufacturing of multi-resolution image by image manufacturing client(25) as well as original image input closing decision step(239) that original image input will be repeatedly executed until final closing and saving total original image input quantity accumulated(240) every input onto variable page.

And then it includes multi-resolution image reducing step for image and divided size calculation step. Related parameter setting step(242-271) for image processing can includes following procedures.

After original image processed and multi-resolution image created, multi-numbers of tile type file will be existed when upload the created image into server, and it is effective to create single file in order to reduce uploading time since long uploading time is required for uploading indicated server by client among data storage part(17) of ASP service operator server(13) in image manufacturing client(25), data storage part(20) of ASP service developer server(12) and data storage part(22) of ASP client server(14)

Accordingly, in case to create single file in single file decision stage(242), creating variable will be set as single file by saving(243) 1 onto variable uniq.

There are some cases to take photograph by digital camera in 90°, that is, to turn the camera vertically depend on the subject. In this case, original image may has to be processed by turning in turning decision step(244) of multi-resolution image processing.

This means, in case to turn original image in turning decision step(244), save and set(248) cw onto variable rot to ensure original image to be turned in clockwise through turning decision step(246), in opposite case, save and set(247) ccw onto variable rot to ensure original image to be turned in anti-clockwise, in case not to turn in turning decision step, save and set(245) no onto variable rot.

In case the image with dense checks, reduced image may looks dizzy. In order to prevent this effect, the image can be reduced and interpolated in reducing by using interpolation method. In case to apply image interpolation in image interpolation decision(249), save 1 to variable inpr and set for image interpolation in image interpolation initial value input step(250).

The process of multi-resolution image reducing step and divided size calculation step(255-258) is as follows: calculate reducing step of original image through reducing step and calculation step(255); save the calculated reducing step onto variable level(256); calculate width and length to divide reduced image through divided size calculation step(257); save(258) calculated width and length size on variable hor and ver respectively; and finally set variable to divide original image reducing step and reduced image that necessary to create multi-resolution image.

When the pages of original image that was input during original image input step(239) move(265), execute Link-RTN(266) repeatedly until closing in link closing decision step(267)

Image saving step as divided multi-resolution image and web page manufacturing step(272-298) including image data replacement step are as follows:

In operator server selection step(272), if multi-resolution image uploading to operator server selected, save(273) 1 to variable ssver; in developer server selection step(274), if multi-resolution image uploading to developer server selected, save(275) 2 to variable ssver; in client server selection step(276), if multi-resolution image uploading to client server selected, save(277) 3 to variable ssver;

This to protect server from hacking by avoiding exposure of ID and password connect to server, with separate driving of ftp module that upload to server after multi-resolution image created.

Save 0 on variable page 1 through initial value setting step(278) and set initial value, execute reduce-RTN step(279) that reduce as much original image as original image page quantity input in original image input step(239), execute divide-RTN step(280) that divide reduced image, however, execute reduce-RTN step(279) and divide-RTN step(280) repeatedly until accumulated value reached same quantity as input image quantity in original image input step(239) by accumulating 1 each time in variable page 1 through page accumulation step(281) whenever reduce-RTN step(279) and divide-RTN step(280) executed.

In first page selection step(283), if Netizen client(24) select first page of original image that is input in original image input step(239) as first page, and then save(284) “1” in variable sPpage; and in first page selection step(283), if does not set first page image as first page and designate arbitrary image and set as first page, set the arbitrary page through initial indication image page designation step(285).

In case original images that input in original image input step(239) are more than one, in case next image displayed in order in automatic indication selection step(286) that decide whether next image to be displayed in order when Netizen client(24) reading it, save(288) “1” in variable Auto, otherwise save(288) “0” in variable Auto.

In order to create web page, set variable Auto, sPage, SavePath, ViewPath, Level, PurchasID, hor, ver as parameter(289), and set field, location et. of link data as parameter, and also save created web page(292).

OCX component part(28) process input original image to multi-resolution image in original image input step(239) and manufacture web page, then horizontal/vertical parameter of initial image is transferred(c1) to application part(27) to save horizontal/vertical size as same size as Netizen client(24) read multi-resolution image.

Application part(27) deliver(c3) horizontal/vertical parameter(c2) to ASP service operator server through network(10), connect(249) inquiry number DB to save in inquiry statistic table of inquiry number DB, save(c4)(296) horizontal and vertical by opening inquiry statistic table of inquiry number DB, close(297) inquiry statistic table of inquiry number DB, release the connection of inquiry number DB.

FIG. 5 shows the composition example of inquiry statistic table. Finally, in uploading(108) the created multi-resolution image and web page to server, if variable ssver in operator server decision step(229) is 1, deliver(d2) the web page(d1) related to multi-resolution image created by connecting(300) to operator server(13), save(d3) by uploading(301) to data storage(17), if variable ssver in developer server decision step(302) is 2, deliver(d4) the web page(d1) related to multi-resolution image created by connecting(303) to ASP service developer server(12), and save(d5) to data storage part(20) by uploading(304), if variable ssver in client server decision step(305) is 3, deliver(d6) the web page(d1) related to multi-resolution image created by connecting(306) to ASP service client server(14), and save(d7) to data storage part(22) by uploading(307).

In releasing step for compacted single file, if variable uniq is 1 in single file creating decision step(308) after completion of uploading to server, release(309) the compaction of single file uploaded on server.

If repeated execution will be performed in repeat decision step(310) that decide whether repeated execution of multi-resolution image manufacturing to be performed, bifurcate(A) to service selection step(214), otherwise release the server connection through server connection release step(311) and close the service.

From now on, Link-RTN, reduce-RTN, divide-RTN will be explained in detail.

In Link-RTN to input text, input(313) text data in text input selection step(312) and save the input data(314); if voice link has been selected in voice link selection step(313), link voice data through voice data link step(316) and save linked data; designate hot spot location through hot spot selection step(318), hot spot location designation step(319), and save hot spot location through hot spot location saving step(320); if image link has been selected in image link selection step(321), insert image to be linked through link image insert step(322); input web address to be linked when click link image through link address input step(323), save link data through link data saving step(324).

FIG. 21 shows practical example of inquiry reception process.

If field has not been selected in decision step(325) for inquiry number field selection, bifurcate to 331 step; in case field has been selected, input(326) field name; save(327) field name in RefName folder; create(328) RefName field in inquiry reception table; create(329) reading start time(RefTS) field; create(330) reading close time(RefTE) field.

As next step, premium setting selection step(331) is followed and input(332) event period starting date, save(333) starting date in variable EventS, input(334) event period closing date, save(335) the closing date in variable EventE and create(336),(337) EventS field and EventE field in inquiry reception table.

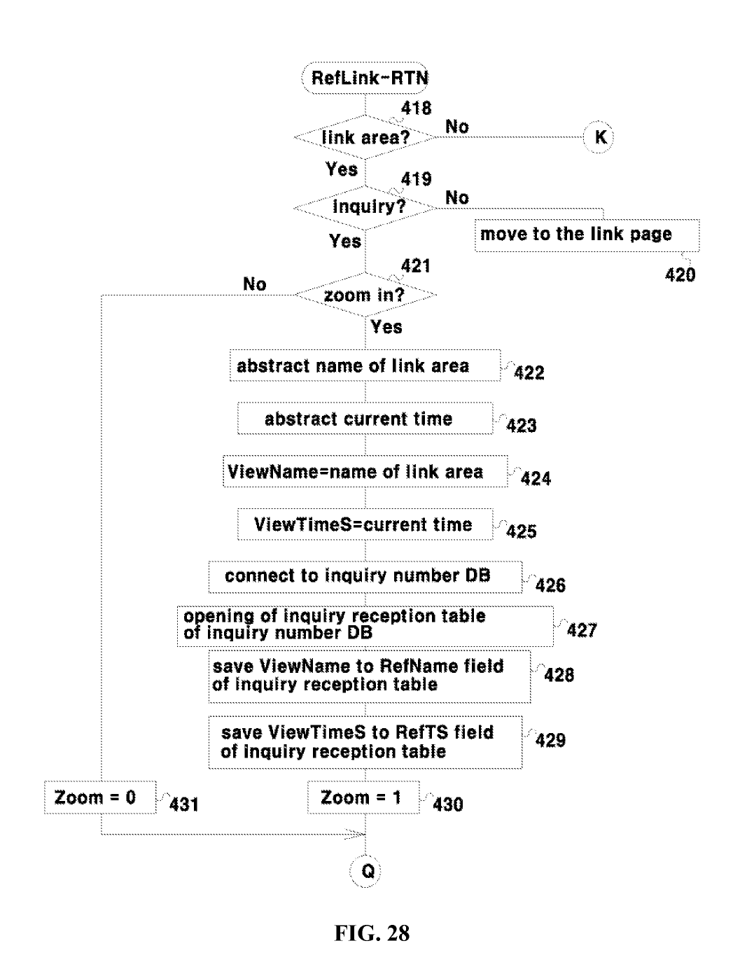

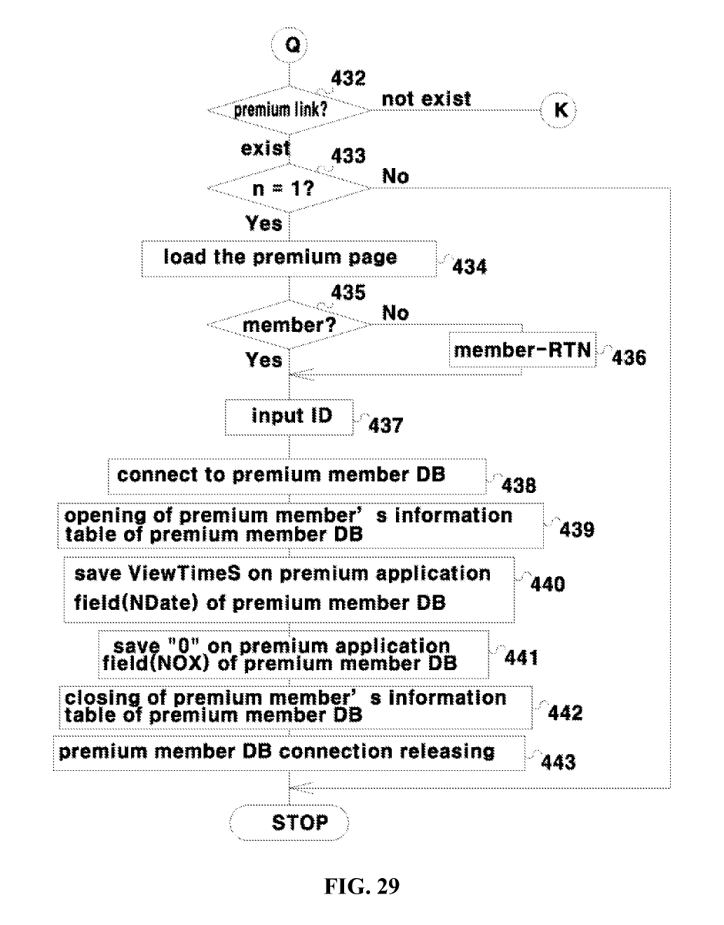

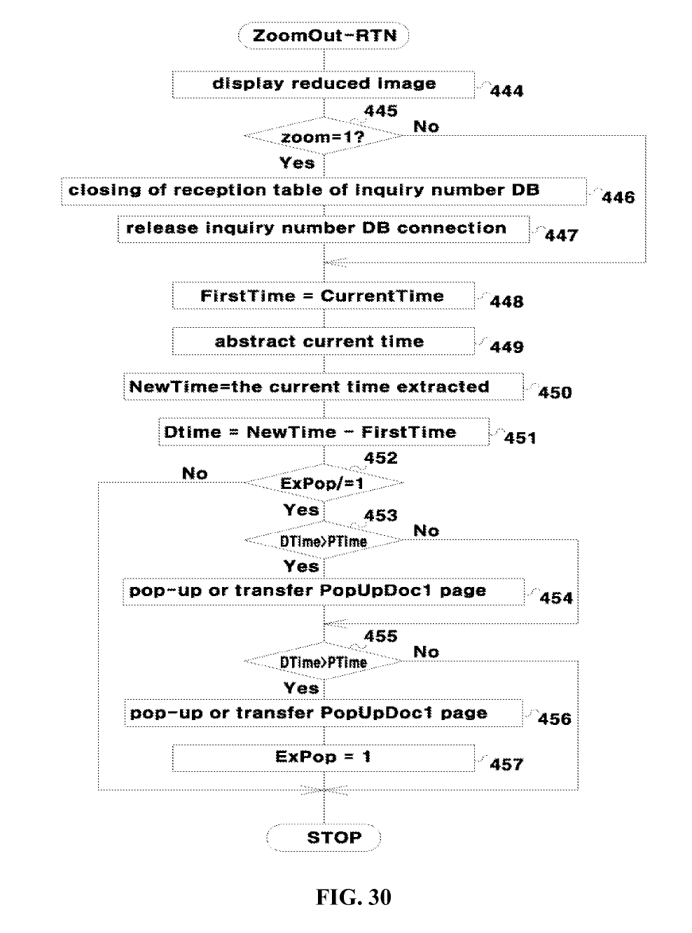

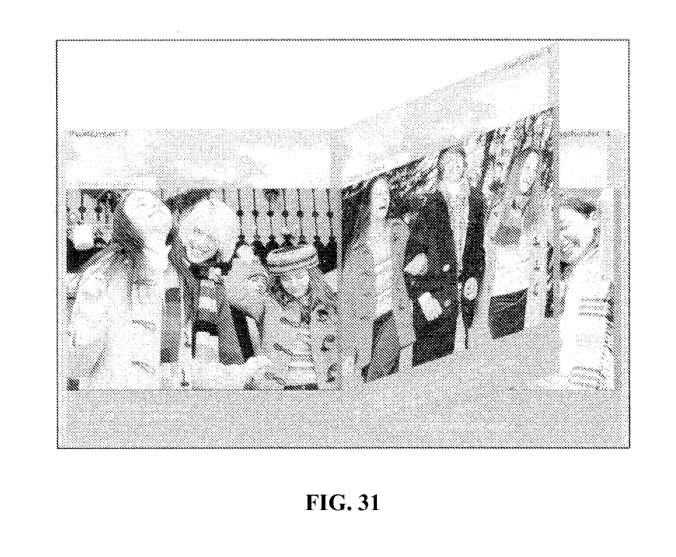

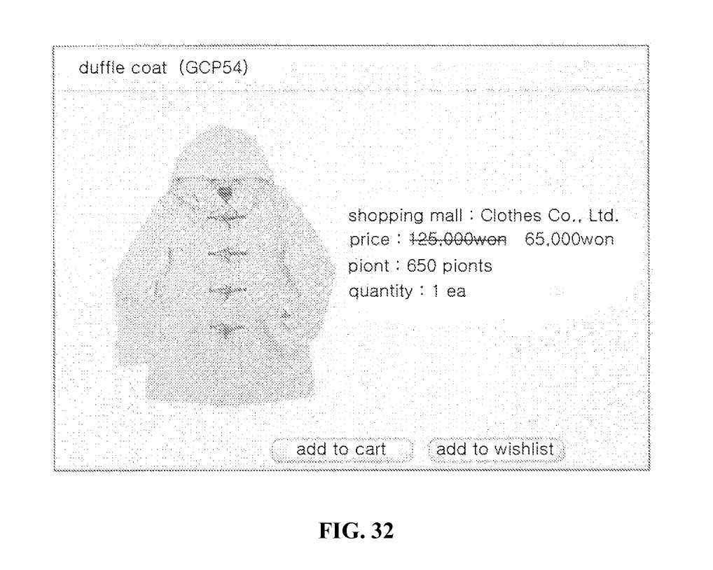

FIGS. 31 and 32 show practical example that popup link page when a certain page clicked after designated as link field.

In reduce-RTN, input 1 to variable N for initialization through initialization step(338), and execute image interpolation initial value input step(250). If decided to interpolate in the interpolation method decision step(339) that to decide whether “1” saved in variable Inpr by execution of image interpolation initial value input step(250), then decide interpolation through interpolation method application step(340). If decided not to apply interpolation method in interpolation method decision step(339) above, then do not apply the interpolation method.

Clockwise rotation decision step(342) is to decide whether input clockwise initial value has been done when non-rotation decision step that decide if non-rotation initial value executed(341) is false.

If this Clockwise rotation decision step(342) is true, rotate original image to clockwise direction. If the Clockwise rotation decision step(342) above is false, rotate original image to anti-clockwise direction through anti-clockwise rotation decision step(344).

Reduce image by 50% through image reduce step(345), and decide whether reduce step value that obtained from reduce step decision step is correspond to the level value accumulated variable N by 1 per each step. If not correspond, save multi-resolution image through image saving step(349). Execute above step repeatedly until value of variable N correspond to the value of reduce step that obtained from reduce step calculation step(255), and if correspond, execute image data replacement(347) and data saving step(348),

Image data replacement(347) above is the work to enable reading only by viewer program provided by mixing the image data fields in order to prevent illegal usage of manufactured image on other ordinary viewer program.

This time, the object of image replacement can be initial images only in consideration of possible lower processing speed and in case security has to be considered important, then can be executed on entire images.

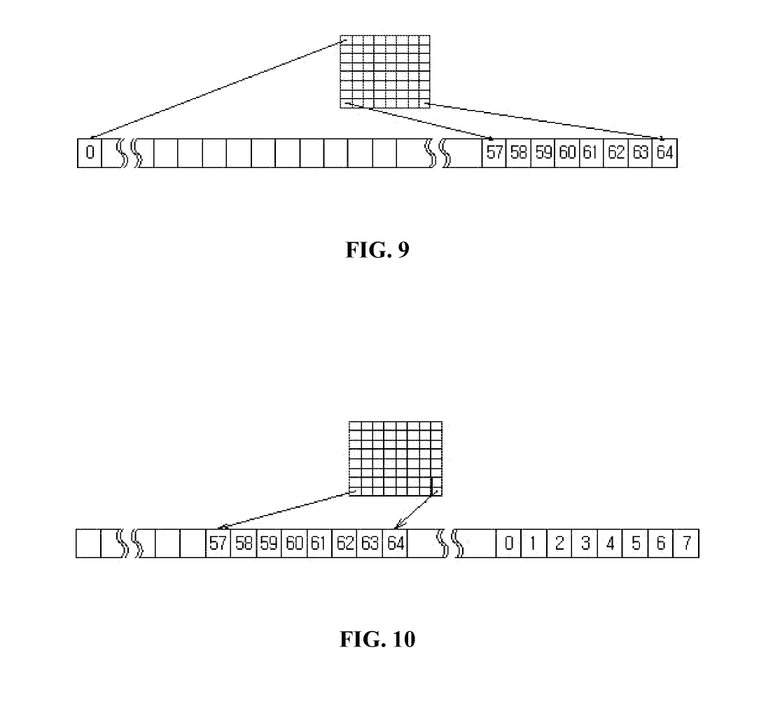

FIG. 9 is the composition example of image data before replacement, and FIG. 10 is the composition example of image data after replacement

In divide-RTN, execute initialization by saving ‘0’ in initial divide value in divide initialization step(352), decide whether loaded image is the image to be rep laced through image decision step(354). If it is the image to be replaced to prevent illegal usage, then replace(355-1) the image as per FIG. 10, if not, execute image divide step(355).

Including input image from original image input step(239) through image divide step(355), load each image reduced in reduce-RTN(279) in loading step(353), and divide each image by horizontal and vertical, save divided image through image saving step(356), accumulate 1 to variable Q1 through divide accumulating step(357), close divide closing decision step(358) if it is true, interpolate to image loading step(353) if it is false.

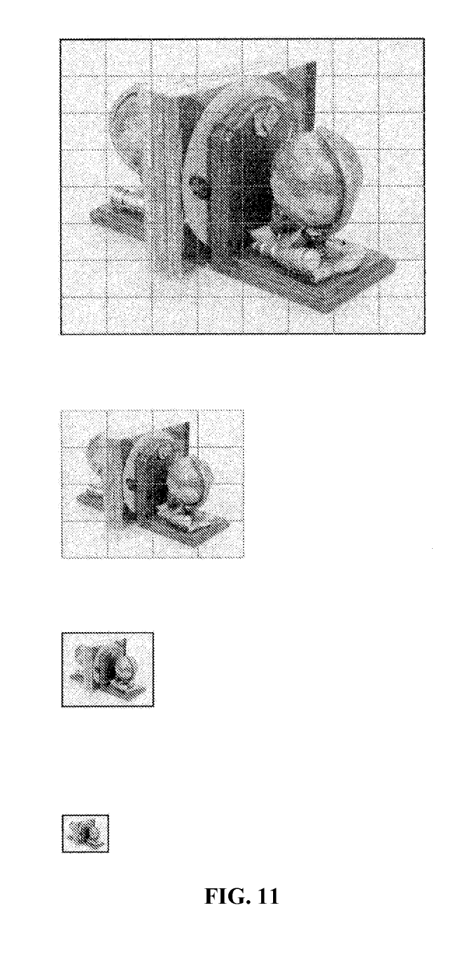

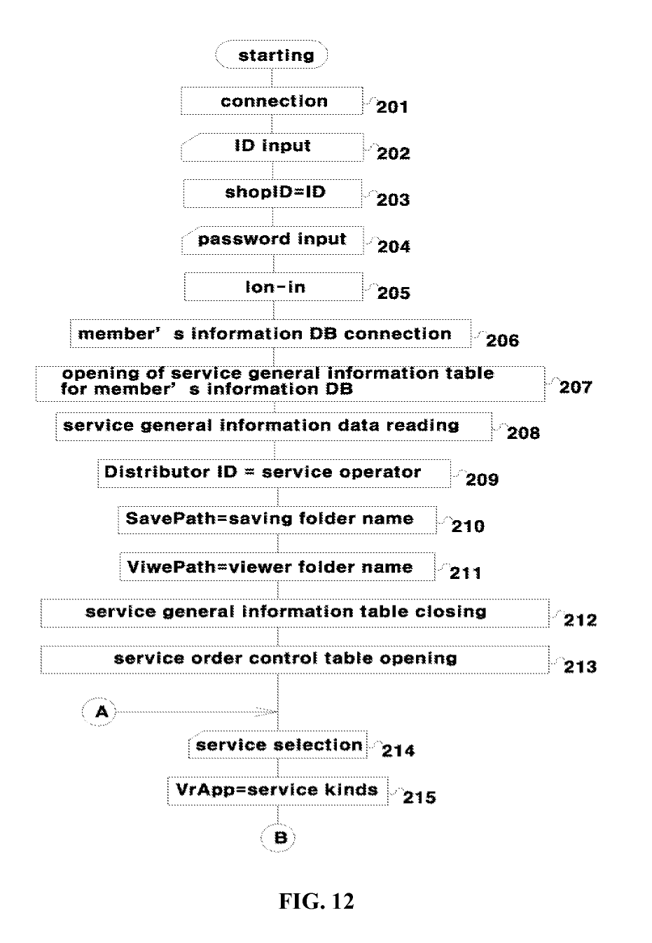

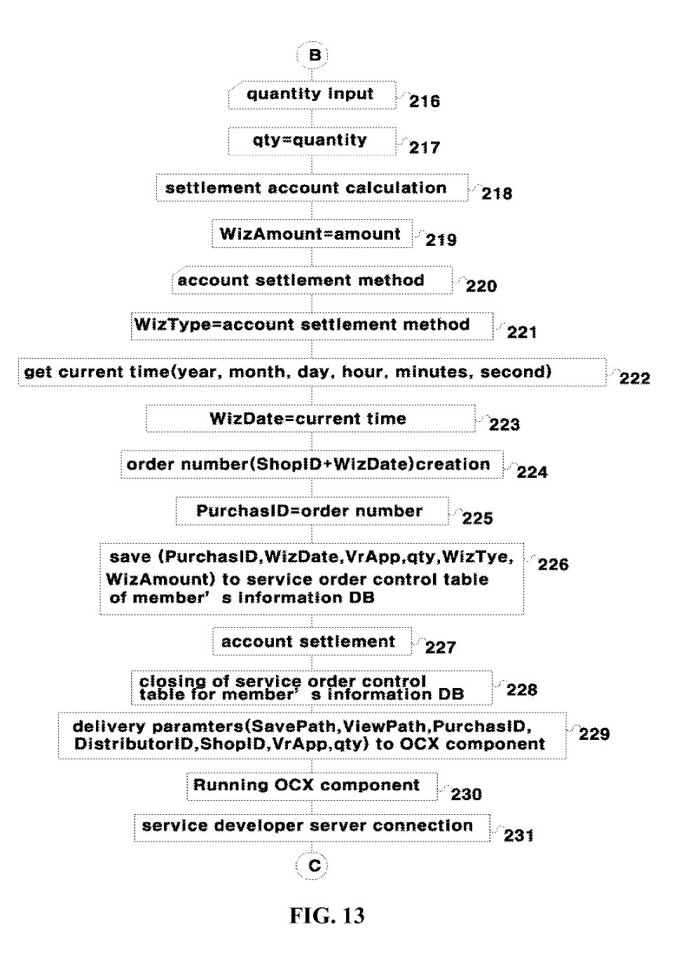

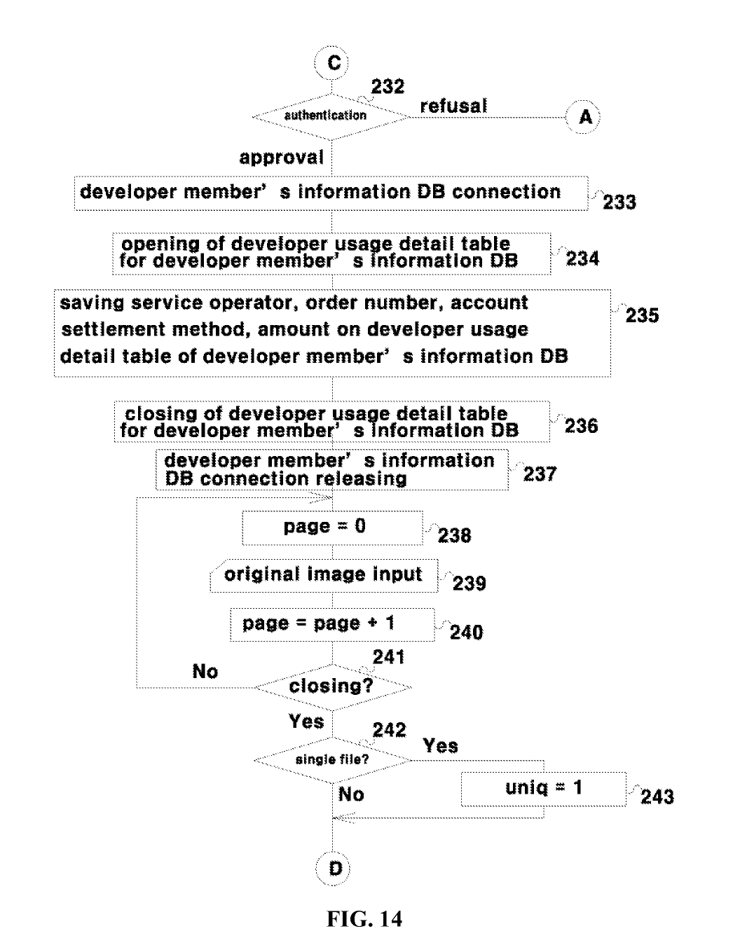

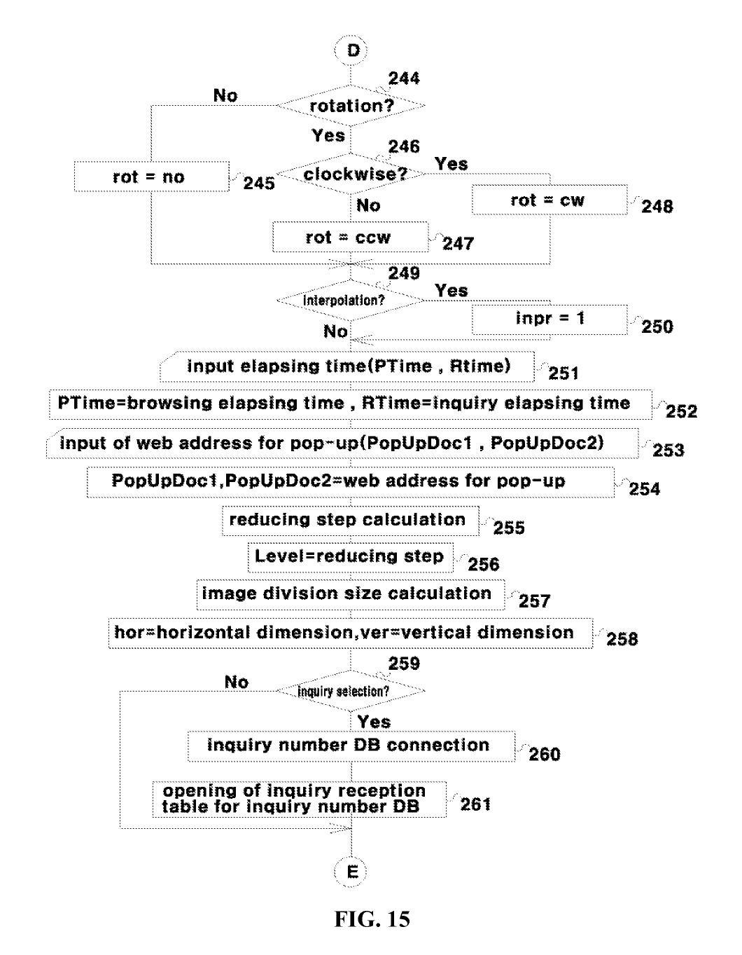

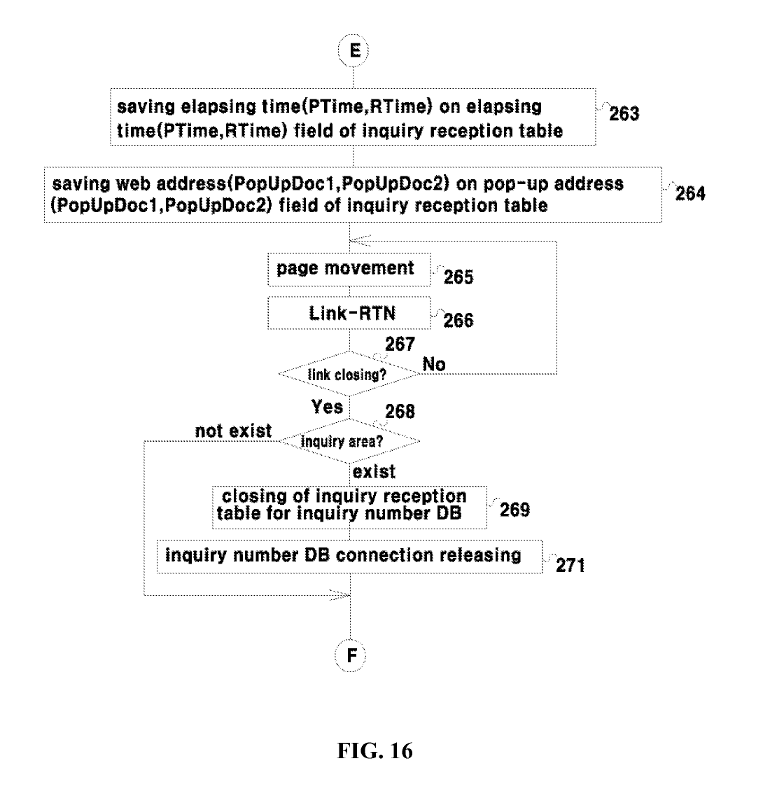

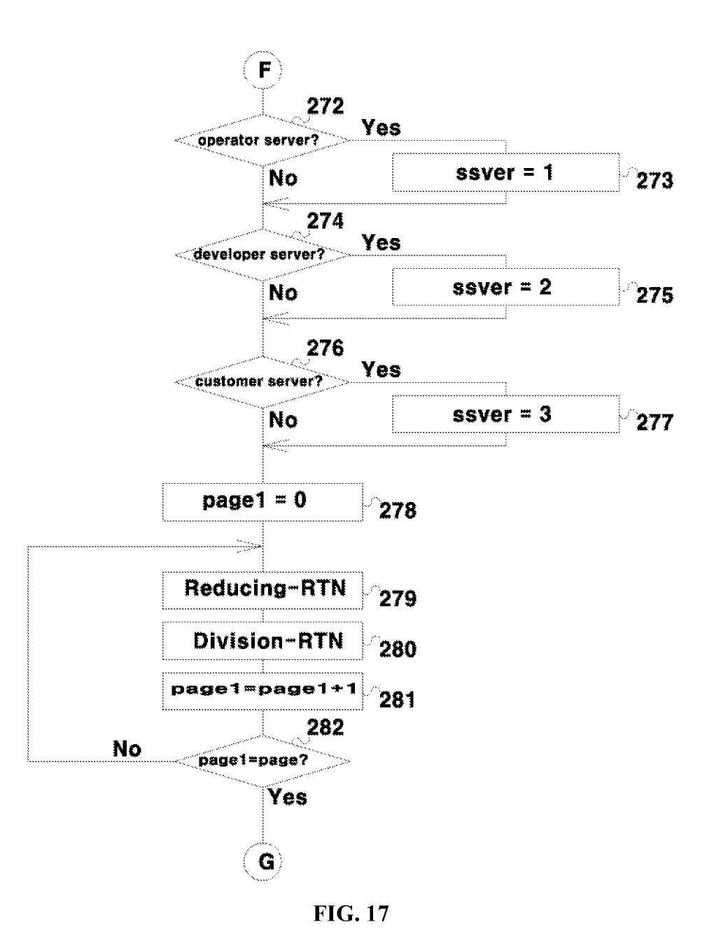

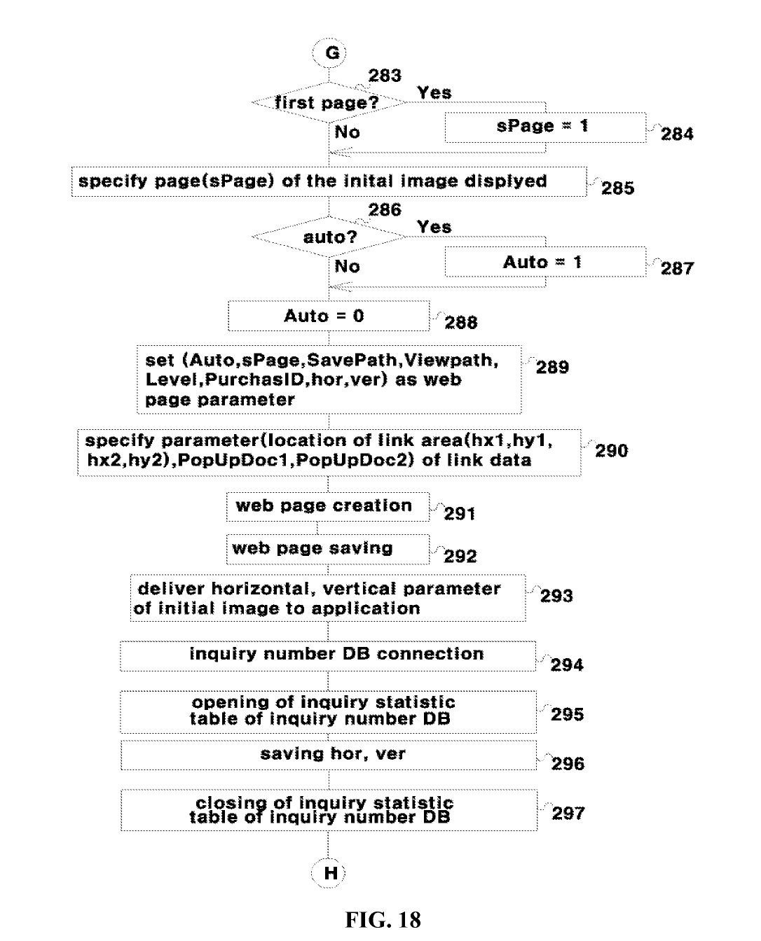

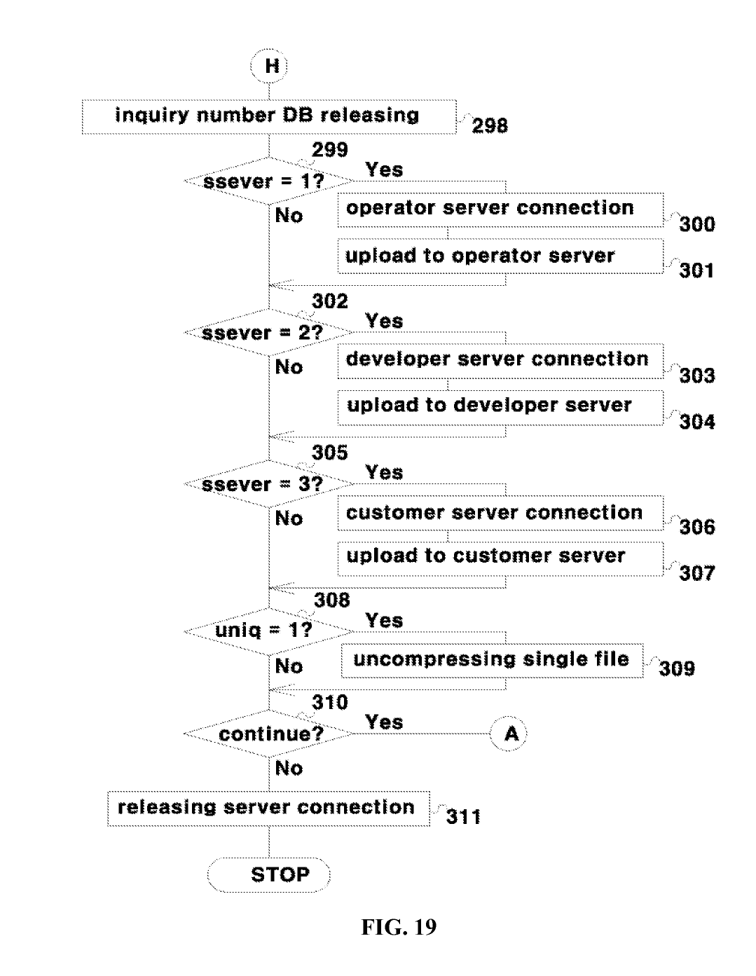

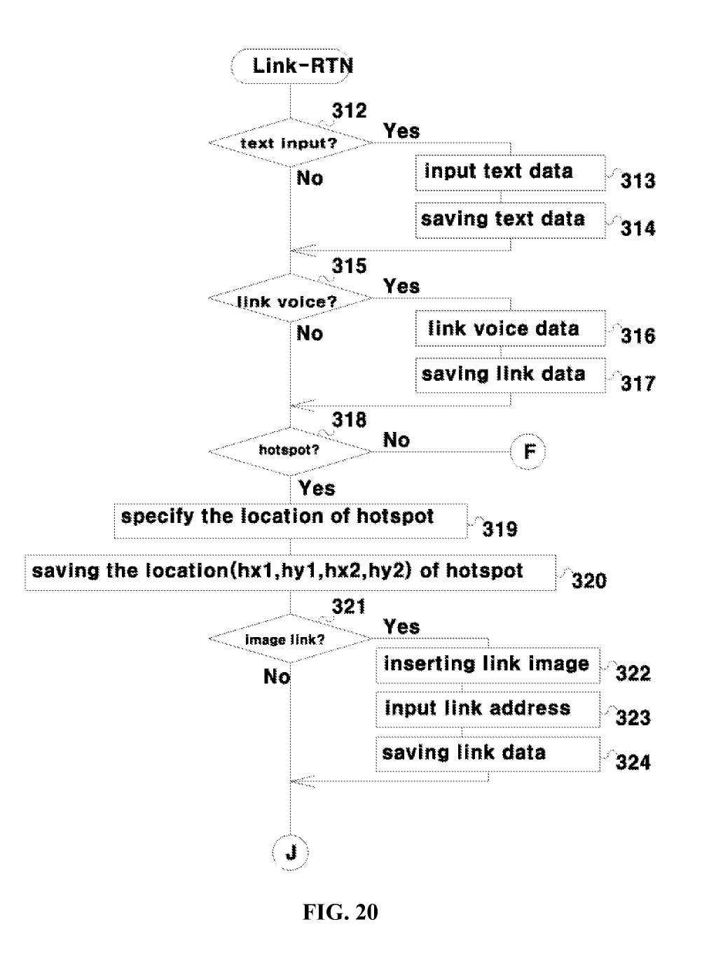

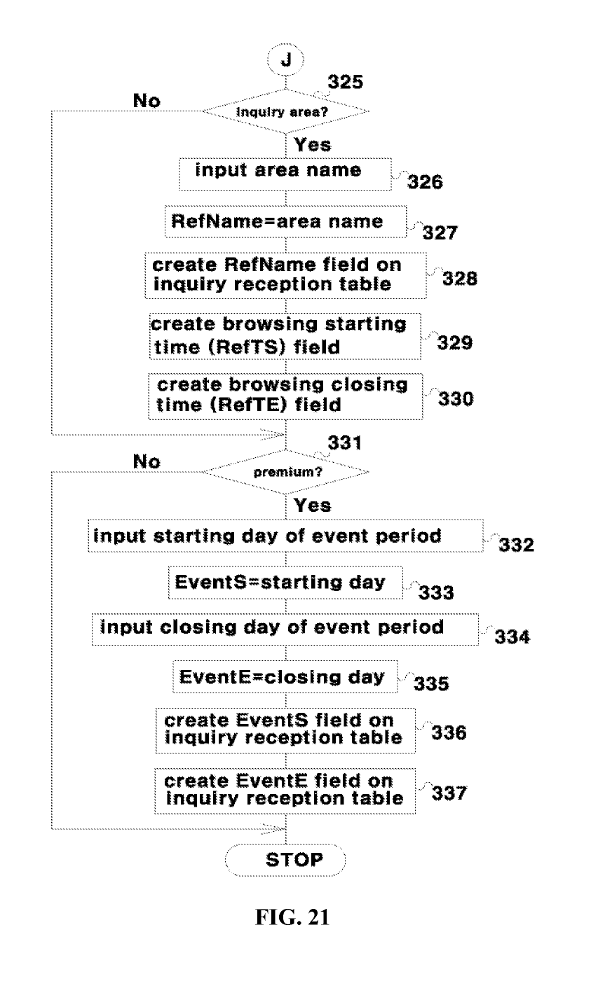

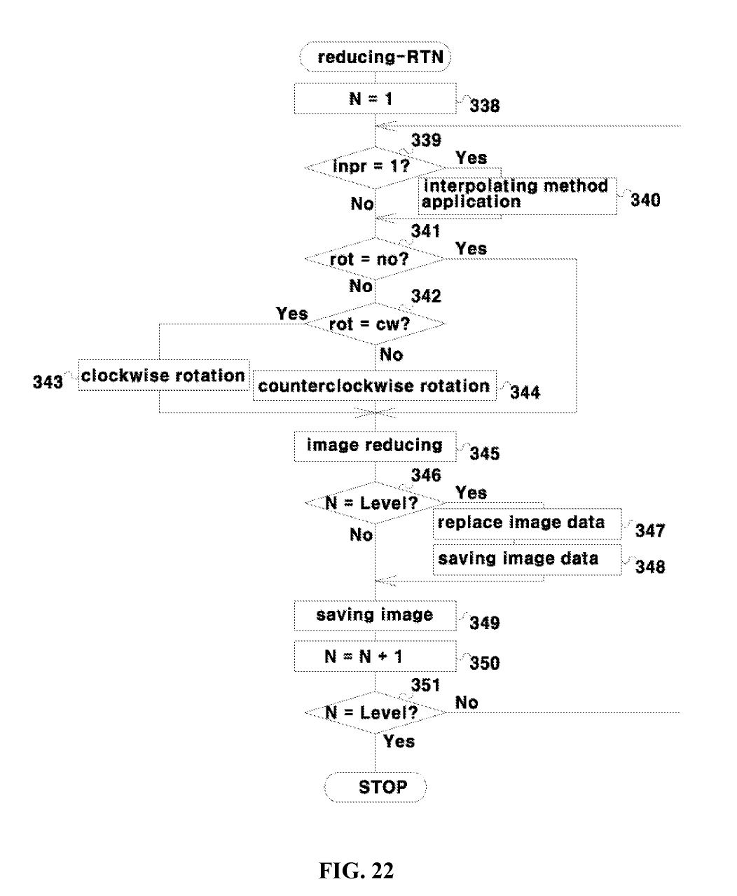

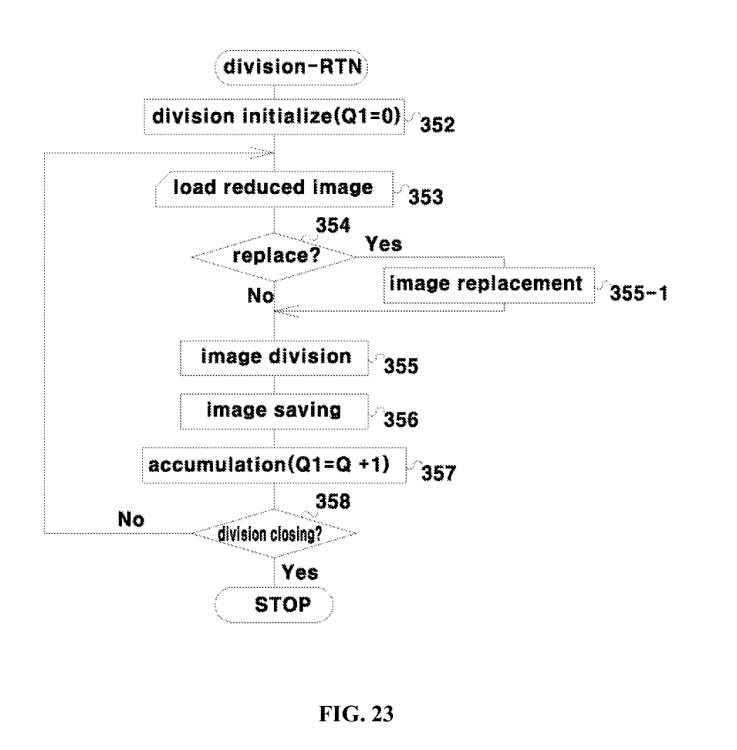

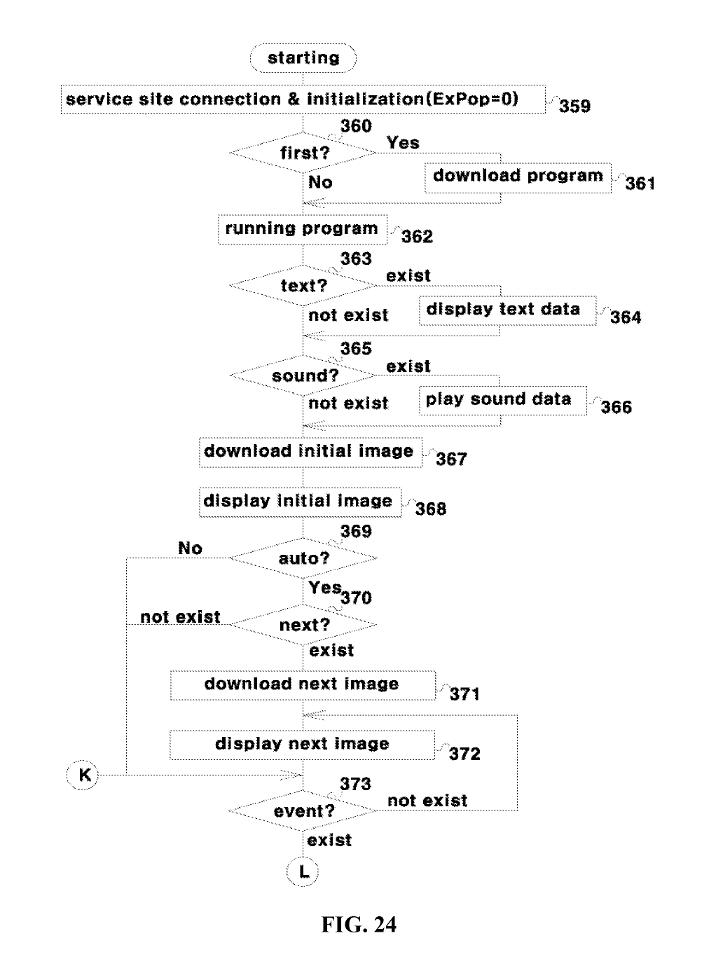

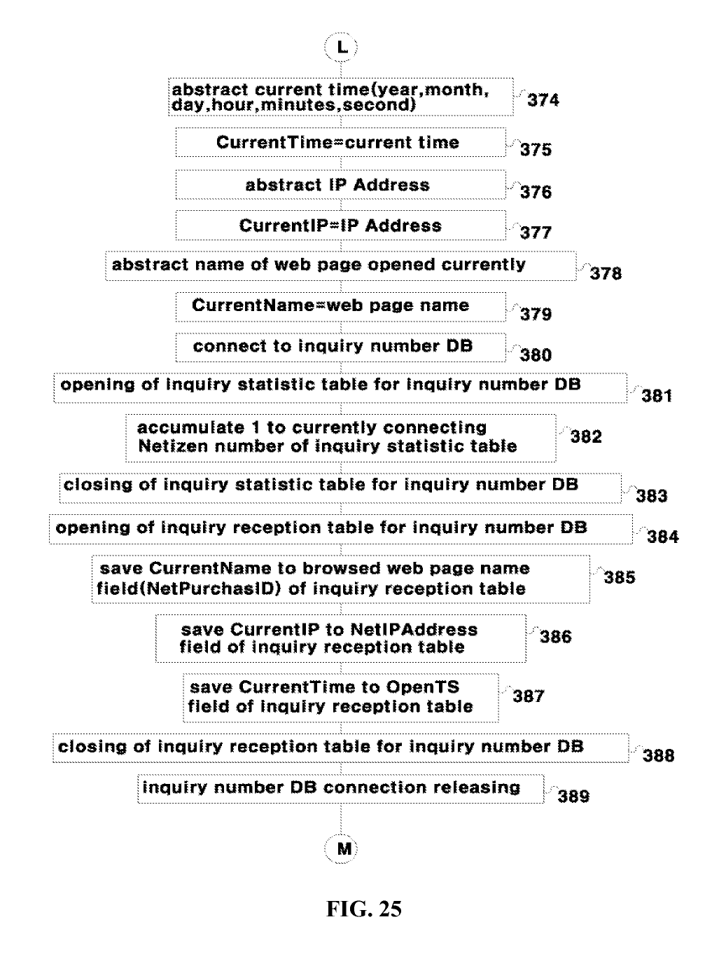

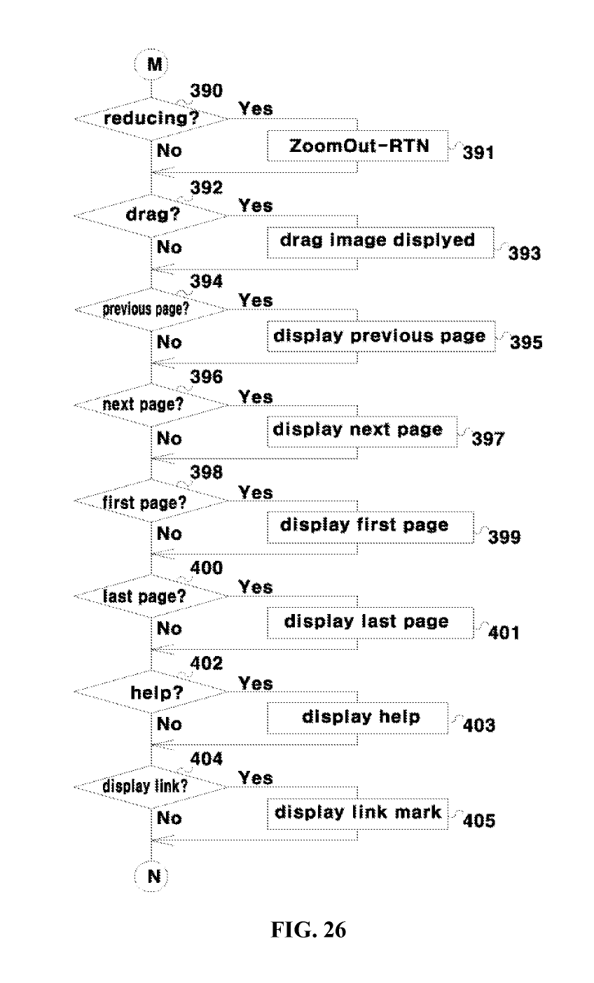

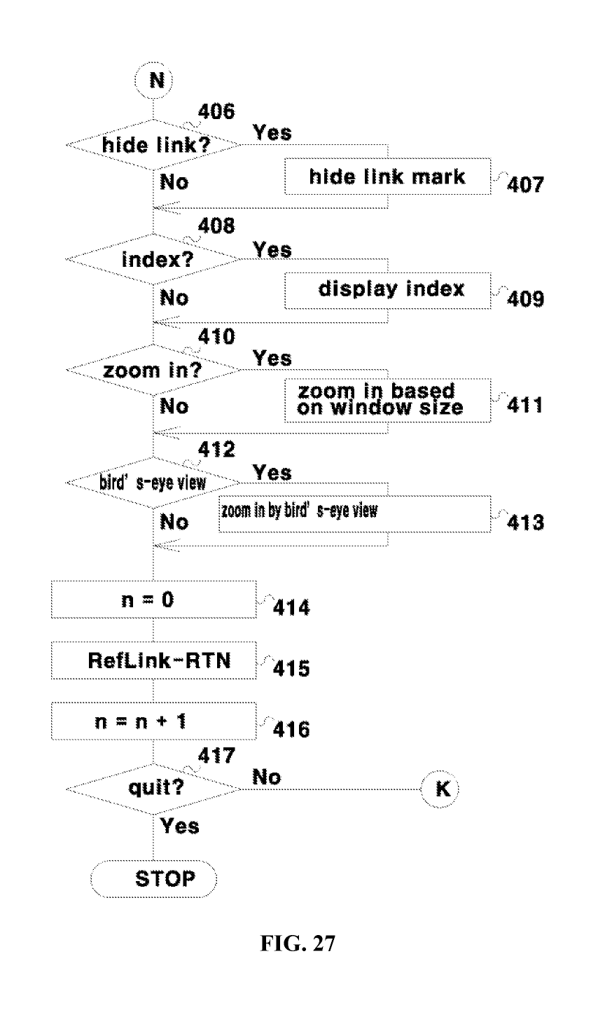

FIG. 11 is the example of image that was reduced and divided through routine above.

Web put up step(112:359-417), to provide manufactured web page to Netizen client, can include Viewer Program Download Step(113:359-361), Initial Image Download and Display Step(114:362-372) and Image Reading Support Step(115:390-417).

Furthermore, the procedure related to advertising activities such as preference survey, premium application display etc. can be added in above step as we explained previously.

Further explanation will be followed separately after the Detailed Description of the Invention.

Viewer Program Download Step mentioned above will be connected to the service site that provide multi-resolution image through Service Site Connection Step(359). If it is the first connection in First Connection Decision Step(360), it will be transferred(e2) to ASP Service Operator Server(13) through Network(10) by the request(e1) of Netizen Client(24) through Program Download Step(361), and can include the Step(113) that download(e9) Viewer Program(e4) which can display multi-resolution image saved in Data Storage Part(17) by the order(e3) of Application Part(15).

In case Viewer Program which can display multi-resolution image has been saved in ASP Service Developer Server(12), the request(e1) of Netizen Client(24) will be delivered to ASP Service Developer Server(12) through Network(10). According to the order(e7) of Application Part(15), it can be composed to download(e9) Viewer Program(e8) that can display multi-resolution image saved in Data Storage Part(20), and also if the Viewer Program which can display multi-resolution image has been saved in ASP Service Client Server(14), deliver(e10) the request(e1) of Netizen Client(24) through Network(10). And also can be composed to enable download(e9) Viewer Program(e12) which can display multi-resolution image that saved in Data Storage Part(22) in accordance with the order(e11) of Application Part(21).

Image Download and Display Step execute downloaded program through Program Executing Step(362); in case text data are exist in Text Data Decision Step(363), display text through Text Data Display Step(364); in Program Executing Step(362) above, decide if any voice data are exist through Voice Data Decision Step(365), play voice data through Voice Data Play Step(366) if any voice data are exist in the Voice Data Decision

Step(365); download initial image from Data Storage Part(17-20-22) through Initial Image Download Step(367); display downloaded initial image through Initial Image Display Step(368); in Automatic Page Turning Decision Step(369) that decide if the value obtained from Next Page Automatic Display Initial Value Setting Step((287,288) is the value to display next page automatically, if the value is true, then decide whether next pages are exist through Next Page Existence Decision Step(370), if next pages is exist, then download next page image through Next Page Image Download Step(371), display next page through Next Page Image Display Step(372), and if not, bifurcate next step of Next Page Image Display Step(372).

In Step(115) that support image reading through viewer program of Netizen, there is mouse event in Mouse Event Decision Step(373) that decide if there is any mouse movement, and execute ZoomOut-RTN (391) in case to receive reducing order in Reduce Order Decision Step(390).

In ZoomOut-RTN (391), display(444) reduced image; in Inquiry Reception Table Closing Decision Step(445) of Inquiry Number DB, if the value of variable is 1, close the Inquiry Reception Table through Inquiry Reception Table Closing Step(446); release the connection of Inquiry Number DB through Inquiry Number DB Connection Releasing Step(447);, if the value of variable Zoom is not 1, bifurcate next step of Inquiry Number DB Connection Releasing Step(447).

In Drag Order Decision Step(392), if drag order is received, drag displayed image through Image Drag Step(393).

In Front Page Movement Order Decision Step(394), if front page movement order received, display front page image through Front Page Image Display Step(395); in Next Page Movement Order Decision Step(396), if next page movement order received, display next page image through Next Page Image Display Step(397); in First Page Movement Order Decision Step(398), if first page movement order received, display first page image through First Page Image Display Step(399); in Last Page Movement Order Decision Step(400), if last page movement order received, display last page image through Last Page Image Display Step(391).

In Help Text Order Decision Step(402), if help text order received, display help text page through Help Text Page Display Step(403); in Link Mark Display Decision Step(404), if link mark display order received, display link mark through Link Mark Display Step(405); in Link Mark Hiding Order Decision Step(406), if link mark hiding order received, hide link mark through Link Mark Hiding Step(407); in Contents Decision Step(408), if contents display order received, display contents through Contents Display Step(409); in Total Enlarge Decision Step(410), if total enlarge order received, enlarge the display as same screen size as initial image screen displayed in reading multi-resolution image through Screen Size Standard Enlarge Step(411).

In Partial Enlarge Decision Step(412), if partial enlarge order received, enlarge the display one quarter screen size of initial image screen displayed in reading multi-resolution image by Netizen Client(24) through Enlarging Step(413), in separate enlarged screen.

Initialize by saving(414) 0 in variable n; execute RefLink-RTN(415); otherwise accumulate(416) in variable n; in Final Decision Step(417), close if true; otherwise bifurcate (k) in order to ready for mouse event.

In Reading Closing Step(417), if mouse event does not select closing of web page reading, bifurcate to k, and close otherwise

To enable preference survey and advertisement for the commodities of Netizen Client is another purpose of this invention, and this is possible by adding some necessary routine. The practical example can be explained as follows by using some relevant symbols in the drawing.

First of all, it is possible to popup or transmit the text for public information and advertisement under a certain condition, and also can be considered to popup premium application display. In this case, step for inquiry elapsed time or setting for web address to popup, step for inquiry elapsed time decision by Netizen clients, step for web page popup in case preset inquiry elapsed time is over, can be added.

To explain concretely, in parameter setting step for image processing in image manufacturing, after a certain time passed from the opening of multi-resolution image web page by Netizen clients(24), activate pop-up text for commodity advertisement, or activate premium application window in case over the set time for browsing elapse time(PTime) for transmit to IP address by Netizen clients, or input(251) browsing elapse time(RTime) for transmission to IP address of Netizen clients(24), and save(252) input browsing elapsed time in variable Ptime.

Input(253) web address(PopUpDoc1) to be displayed pop-up after browsing elapsed time and web address(PopUpDoc2) to be displayed pop-up after inquiry elapse time, save web address to be displayed pop-up in variable PopUpDoc1 after set browsing elapsed time, and time setting is possible so that pop-up to be activated for premium page or advertising text or to be transferred to IP address of Netizen clients(24) if a certain time is elapsed when Netizen clients(24) browse multi-resolution image web page through the step to save(254) the web address to be displayed pop-up to variable PopUpDoc2 after the set inquiry elapse time.

Also, in web page manufacturing step, the name of web page to be displayed pop-up will be saved(290) as parameter.

In Inquiry Elapsed Time Decision Step and Browsing Information Decision Step of Netizen Clients, decide existence of mouse movement in Mouse Event Existence Decision Step(373), and if yes, abstract the current time as year, month, day, hour, minute, second based on the server(11) that provide ASP service through Current Time Abstract Step(374).

Save Current Time abstracted through Current Time Saving Step(375), abstract(376) IP address of Netizen client(24), save extracted IP address to variable CurrentIP through IP Address Saving Step(377), abstract the name of web page that currently browsed by Netizen client through Web Page Name Abstract Step(378), save extracted web page name to variable CurrentName through Web Page Name Saving Step(379).

Open inquiry reception table of inquiry number DB through Inquiry Reception Table Opening Step(384) of inquiry number DB, save web page name, CurrentName, that browsing by Netizen client(24) to the browsed web page name (NetPurchasID) field of Inquiry Reception Table through Web Page Name Saving Step(385),

Save IP Address of Netizen client(24), CurrentIP, to NetIpAddress field of Inquiry Reception Table through IP Address Saving Step(386), save Current Time in OpenTS field, the web page browsing start time of inquiry reception table through Current Time Saving Step(387), close Inquiry Reception Table of inquiry number DB through Inquiry Reception Table Closing Step(388) of inquiry number DB, release the connection of inquiry number DB through Inquiry Number DB Releasing Step(389).

Through above process, the starting time of browsing for multi-resolution image by Netizen client(24), IP Address and browsing web page name can be saved in DB, additional information can be provided by activation prepared pop-up of the web page related to advertisement or relevant information to Netizen client(24), after a certain time has been passed after browsing, and also can provide or deliver direct mail or relevant information to the address of Netizen client(24).

In case preset inquiry elapse time is over, the steps to activate pop-up will be as follows: save(448) the time stored in variable CurrentTime to variable FirstTime; abstract Current Time through Current Time Abstract Step(449) above; save(450) Current Time of server to variable NewTime; save(451) the elapse time that calculated by reducing previous time(FirstTime) from current time (NewTime) to variable Dtime; decide whether the variable ExPop is 1 or not through Pop-up Execution Exsistence Step(452); and if not 1, that is, pop-up has not been executed in Pop-up Execution Exsistence Step(452); decide whether the value saved in variable Dtime is higher than the value saved in variable Ptime, through Browsing Elapse Time Decision Step(453); the value saved in variable Dtime is higher than the value saved in variable Ptime, activate pop-up PopUpDoc1 page through Pop-up Step(454) or transfer to IP Address of Netizen client(24); if the time to start browsing for inquiry frequency survey field on specific area is longer than the time preset elapse time(RTime) in Inquiry Elapsed Time Decision Step(455), activate preset pop-up page PopUpDoc2 or transfer(456) to IP Address; save 1 to variable ExPop in order to notify that pop-up or transmission has been executed through Pop-up Execution Initialization Step(457), and close.

And decide whether variable ExPop is 1 or not, through Pop-up Execution Existence Decision Step(452), if 1, then close ZoomOut-RTN.

In order to survey preference of client's goods, following steps can be added:

Parameter Setting Step in relation to inquiry elapse time on hot spot field and web address to be activated pop-up; Inquiry Number Selection Decision Step that decide whether the hotspot field is for inquiry number survey; Browsing Information Collecting Step of Netizen client for hotspot field; Recording Step for the result on inquiry number recording DB; and Premium Setting Step for hotspot field.

The steps to set the inquiry elapse time and web address for pop-up related to hotspot mentioned above are as follows: in parameter setting step for image processing in image manufacturing, select and set whether to perform inquiry frequency survey on preset field when browsing multi-resolution image through Inquiry Number Selection Decision Step(259); if select inquiry frequency survey, connect to inquiry number DB through Inquiry Number Connection Step(260); save(263) inquiry elapse time(RTime) by opening(261) Inquiry Reception Table of inquiry number DB; save(264) pop-up address(PopUpDoc2); if preset inquiry number survey in Inquiry Field Decision Step(268), close(269) inquiry reception table of inquiry number DB; can preset to release(271) connection of inquiry number DB.

In addition, following procedure can be added; if selected to survey inquiry frequency number by designate hotspot field as inquiry number field through Inquiry Number Field Selection Step(325), in put field name through Field Name Input Step(326); save(327) input field name to variable RefName; create(328) Field Name (RefName) onto Inquiry Reception Table of inquiry number DB; create(329) Browsing Start TimeField(RefTS); create(330) Browsing Close TimeField(RefTE).

In FIG. 16, if survey of inquiry number has been preset in Inquiry Number Field Decision Step(268), close(269) Inquiry Reception Table of inquiry number DB and add the Step to Release(271) inquiry number DB connection.

In Inquiry Number Selection Decision Step to decide if hotspot field is for inquiry number survey, save 0 to variable n in Inquiry Number Browsing Initialization Step(414) when Netizen client browse manufactured image, browse inquiry frequency number through RefLink-RTN(415), accumulate 1 to variable n through Inquiry Number Accumulation Step(416) after browsing, in Closing Decision Step(417), close if true, otherwise bifurcate(k) in order to ready for mouse event.

In browsing information collection step of Netizen client for hotspot field, in case the result is true in Link Inquiry Number Decision Step(419), decide if the mouse event is enlargement order through Inquiry Number Enlargement Order Decision Step(421), and abstract field name through Field Name Abstract Step(422).

Abstract current time of server through Current Time Abstraction Step(423), save extracted field name to variable ViewName through Field Name Saving Step(424), save extracted current time to variable ViewTimeS through Current Time Saving Step(425).

Connect inquiry number DB through Inquiry Number Connection Step(426), open Inquiry Reception Table of inquiry number DB through Inquiry Reception Table Opening Step(427), save extracted ViewName to RefName Field of Inquiry Reception Table through Field Name DB Saving Step(428),

save extracted ViewTimeS to RefTS Field of Inquiry Reception Table through Current Time DB Saving Step(429).

Through Inquiry Number Enlargement Order Initialization Step(430), if mouse location is in Link Field, if Link Field id for Inquiry Number Survey, and if Mouse Event is enlargement order, then save 1 to variable Zoom. And decide if Mouse Event is enlargement order through Inquiry Number Enlargement Order Decision Step(421). If it is true, then save 0 to variable Zoom through Inquiry Number Non-Enlargement Order Initialization Step(431)

In the step to record the inquiry result onto the DB for Inquiry Number Recording, following procedure can be added: connect to Inquiry Number DB through Inquiry Number DB Connection Step(380); open Inquiry Statistic Table of Inquiry Number DB through Inquiry Statistic Table Opening Step(381) of Inquiry Number DB, accumulate 1 to Current Connection Netizen Number(NetNo) of Inquiry Statistic Table of Inquiry Number DB through Connecting Number Accumulation Step(382), and also the step to close Inquiry Statistic Table of Inquiry Number DB through Inquiry Statistic Table Closing Step(383) of Inquiry Number DB.

In case to set premium in Premium Setting Selection Step(331), input event period starting day through Event Period Starting Day Input Step(332), save(333) the input starting day in variable EventS, input the event period closing day through Event Period Closing Day Input Step(334), save(335) the input event closing day in variable EventE, create(336) event starting day(EventS) field at Inquiry Reception Table of inquiry number DB, and create(337) event closing day(EventE) field at Inquiry Reception Table of inquiry number DB.

On the occasion of browsing by Netizen client in Premium Link Decision Step(432), if true, then decide if Inquiry Number Accumulation Step(416) executed 1 only, therefore, if the Premium Page Loading is the first time through Premium Page Previous Execution Decision Step(433), then loading Premium Page that can apply the premium through Premium Page Loading Step(434), decide if existing member through Existing Member Decision Step(435); in case not existing member, then suggest to join as a member through Affiliation- RTN(436); in case verified as existing member in Existing Member Decision Step(435), input ID through ID Input Step(437); connect to premium member DB through Premium Member DB Connection Step(438); open Member Information Table of Premium Member DB through Member Information Table Opening Step(439) of Premium Member DB; save ViewTimeS in Premium Application Date(NDate) Field of Premium Member DB; save(441) “0” in Premium Application Existence(NOX) Field of Premium Member DB; close Member Information Table of Premium Member DB through Member Information Table Closing Step(442) of Premium Member DB; release connection of Premium Member DB through Premium Member DB Connection Releasing Step(443).

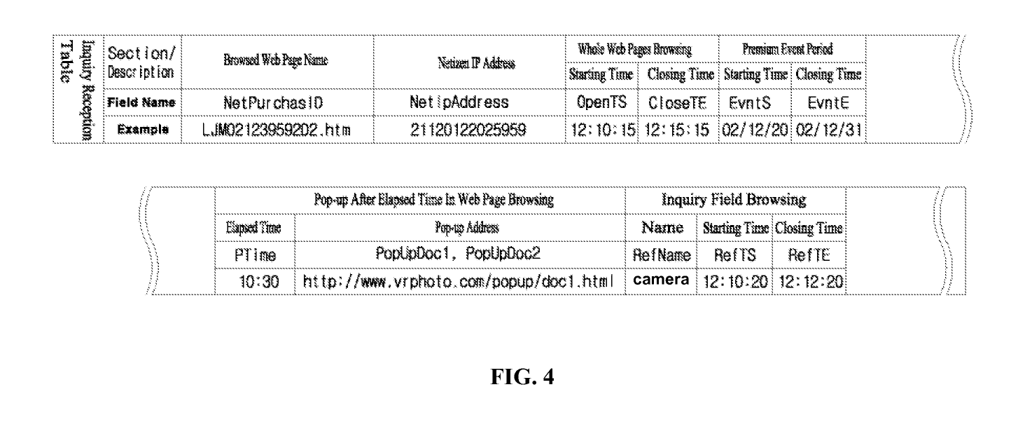

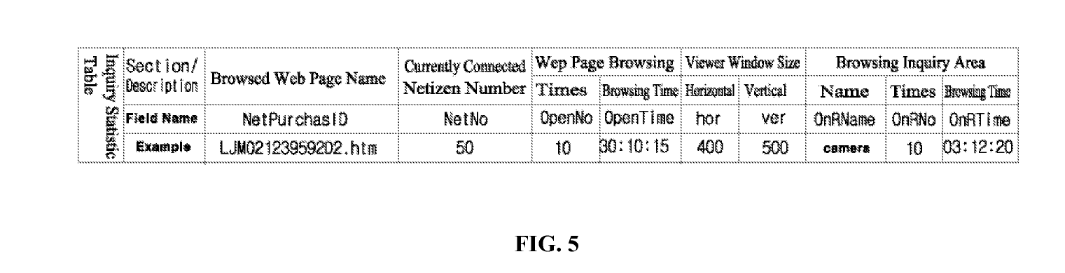

FIG. 4 shows example of composition of Inquiry Reception Table mentioned above.

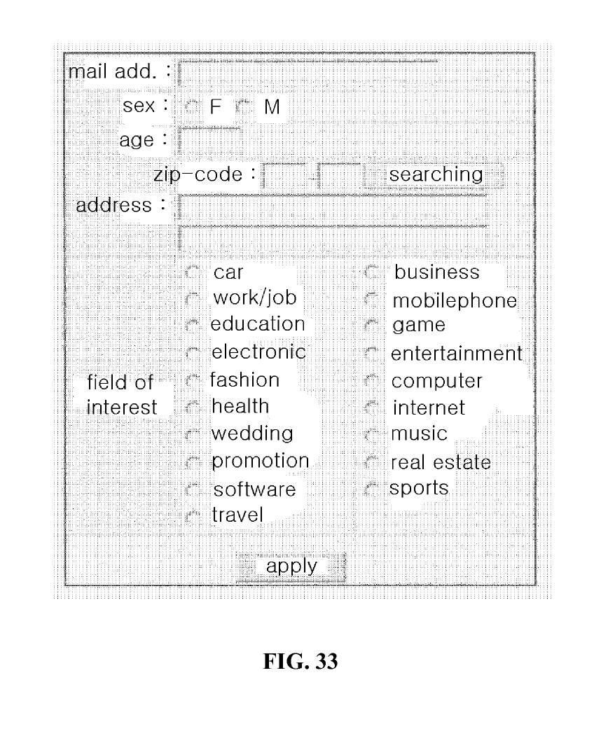

FIG. 33 shows example of practical work of Premium Application Form.

In addition to the equipments and methods described above, this invention can also provide ordinary people, who purchase and operate shopping mall that possessed and supplied in bundling by shopping mall engine developing company, so that the ordinary users can manufacture multi-resolution image and provide to other people easily, by providing as shopping mall engine developing company supply multi-resolution image manufacturing program and viewer program to middle/large scale portal site.

Furthermore, this invention provides not only in bundling to shopping mall engine but also to general application program such as POS(Point Of Sales), human resources and payment management program, material/inventory control program in bundling so that the application program can be purchased and used, and then in case multi-resolution image required, it can be used conveniently as per required kind of service and quantity in accordance with the procedure of this invention.

So far some useful practical examples are described on this invention.

Anybody who has basic knowledge in the field of this invention can understand fundamental features of the invention that can present in various forms of application.

In addition to some example of the application described above, this invention can provide any transformed application practically from non-fundamental part, for example, any mutual link, transmission or functional unification of specific data base between ASP Service Developer Server and ASP Service Operator Server will be allowed in the range unless it cause any harmful effect to the nature of this invention , especially, composing elements such as practically expected variable and values saved in the variable can be added or reduced or revised if necessary.

Therefore, the practical examples described above have to considered not in limited point of view but illustrative point of view. The scope of the invention is mentioned not in the description above but presented in the category of patent application and all the differences in the same scope should be construed as included in this invention.

### INDUSTRIAL APPLICABILITY

According to the external appearance of this invention, it may looks as operator provide the total process from manufacturing to the application of business that used manufactured image, and amazing growth of related market is expected since image manufacturing clients can make multi-resolution image without any professional know-how and can uploading to sever, put-up on web as well easily and with low cost.

And by checking OCX component if the usage is appropriate, proper user paid monthly fee can use in ordinary process and users who has not proceed payment may be restricted. Therefore, developer and operator can be ensured increased turnover and proper profit. Furthermore, clear account settlement between developer and operator can be achieved by the record of the usage details.

As an additional effect of this invention, the business owners can expect efficient advertisement and sales of the commodities by analysis of trends and features of Netizens through the study for the inquiry numbers based on the multi-resolution images linked to DB for a specific region.

1. A method of executing an Application Service Provider (ASP) Service that provides a multi-resolution images using Multi-Web Server, the method comprising:
a) connecting an Image Manufacturing Client to Multi-Web Server;
b) downloading an Image Manufacturing Program from the Multi-Web Server to the Image Manufacturing Client, the Image Manufacturing Program composed of an Application Part and an OCX Component Part;
c) receiving, with the Application Part, at least one service parameter defining a desired image processing task to be performed on an original image;
d) delivering each service parameter from the Application Part to the OCX Component Part;
e) inputting the original image to the Image Manufacturing Client by using the OCX Component Part;
f) executing a multi-resolution image reducing routine and a divided size calculation routine in the OCX Component Part to obtain at least one image reduction parameter as a function of the service parameter, wherein each image reduction parameter defines one of a multiplier or a dimension to convert the original image to one of the reduced resolution images;
g) manufacturing a web page, the manufacturing step being executed in the OCX Component Part and including dividing the original image data according to the image reduction parameters to generate the multi-resolution image and storing the multi-resolution image on the web page, wherein the multi-resolution image includes the original image stored in at least a first resolution and a second resolution;
h) uploading the web page to one of a plurality of web servers present on the Multi-Web Server, the web server being designated by the Image Manufacturing Client using the OCX Component Part;
i) providing access to the web page by an ordinary Netizen client using the web server designated by the Image Manufacturing Client in step g), thereby providing the multi-resolution image using the Multi-Web Server.

2. The method of claim 1, further comprising the steps of:
ba) receiving at least one authentication parameter for authenticating a membership of the Netizen client to the ASP Service via the Image Manufacturing Client;
bb) creating a detail of usage at the Image Manufacturing Client between the Application Part and the Multi-Web Server, the detail of usage including a service order and an account settlement.

3. The method of claim 2, wherein after executing the creating step bb), further including the steps of:
bc) delivering the authentication parameter from the Application Part necessary to record an authentication of the detail of usage to the OCX Component Part; and
bd) authenticating the detail of usage to verify that the service order and the account settlement are processed before the step of manufacturing the web page, and recording the detail of the usage to a relevant DB by delivering the detail of the usage to the OCX Component Part.

4. The method of claim 1, further comprising the steps of: releasing and saving an abstraction in case an uploaded file is extracted in a single file.

5. The method of claim 1, wherein the parameter setting step e) includes setting an Inquiry Elapsing Time and a web address activated as a pop-up display so as to activate an advertising test, and delivering a premium application window to an internet address of the Netizen client when a web page browsing time exceeds a preset time period;
and wherein the web page providing step h) includes activating the pop-up display on the web page if the Inquiry Elapsing Time exceeds the preset time period.

6. The method of claim 1, wherein step e) further includes setting a Hotspot Field Inquiry Elapsing Time and a web address to be activated as a pop-up display if a Hotspot Field, manufactured to survey a preference of a client's commodities, is for investigation of an inquiry number;;
and wherein the web page providing step h) includes the step of determining if the Hotspot Field that is manufactured for surveying of a preference for client's commodities is for investigation of an inquiry number; and recording a result in a DB for Inquiry Number recording.

7. The method of claim 6, wherein step e) further includes setting a Premium Related Information, wherein the web page providing step h) includes loading a Premium Page for a first loading case only; wherein the step h) proceeds upon verifying whether a Member Affiliation to the ASP Service is an existing or a new member.

8. A method for uploading a multi-resolution image to a Multi-Web Server, the method comprising the steps of:
transferring at least one service parameter, which defines a desired image processing task to be performed on an original image, mutually between an Application Part and an OCX Component Part,
manufacturing the multi-resolution image using at least one of the service parameters, wherein the multi-resolution image includes the original image stored in at least at first resolution and a second resolution;
uploading the multi-resolution image to the Multi-Web Server; and
browsing the uploaded multi-resolution image at a client terminal via the Multi-Web Server.

9. The method of claim 8, wherein the uploading step includes saving a folder name called SavePath for the multi-resolution image and saving a web page name PurchaseID for a web page delivered from the Application Part to the OCX Component Part.

10. The method of claim 8, further comprising the step of creating an ID by combining a ShopID for the web page and an abstracted current time.
